(19) United States
(12) Patent Application Publication
(10) Pub. No.: US 2006/0272512 A1
(43) Pub. Date: Dec. 7, 2006

(54) Connecting member for the handle of a pan

(76) Inventor: Chung-Che Wang, Tainan City (TW)

Correspondence Address: LEONG C LEI, PMB # 1008, 1867 YGNACIO VALLEY ROAD, WALNUT CREEK, CA, 94598, US

(21) Appl. No.: 11/142,195

(22) Filed: Jun. 2, 2005

(51) Int. Cl. A47J 37/12

(52) U.S. Cl. 99/403

(57) ABSTRACT

A connecting structure for the handle of a pan is disclosed. The connecting structure has an element which can conduct heat energy and the top face of the connecting member is provided with a temperature sensing element, thereby the heat from the pan body is transferred via the edge of the pan body to the connecting member, so that the temperature sensing element of the connecting member can detect the temperature and a color change is obtained to provide an indication of temperature.

### BACKGROUND OF THE INVENTION

(a) Technical Field of the Invention

The present invention relates to a connecting member, and in particular, the connecting member which allows the temperature of the pan to be seen.

(b) Description of the Prior Art

In cooking, controlling the temperature of the heating pan is important. For an inexperienced chef, it is not easily to adjust the temperature of the pan while also controlling the heat.

Conventionally, there are temperature sensors available in the market used for detecting the temperature of the pan, for instance, Taiwanese Patent Publication No. 446177 entitled “Clipping Plate Of A Socket With Color Change Corresponding to Temperature”, and Taiwanese Patent Publication No. 306267 entitled “Pacifier With Color Change Liquid Crystal Plate”, and Taiwanese Patent Publication No. 545575, entitled “Sensing Device For Stirring Food”, which comprises a body having a stirring portion and a connecting member which is connected to the stirring portion which is also mounted to the shaft section for holding. When the stirring portion is in contact with heat, the heat will transfer to the shaft portion and the temperature sensor will indicate the temperature at the stirring portion. This temperature device does not indicate the exact temperature of the pan for placing food, which should be placed at an appropriate temperature. Accordingly, it is an object of the present invention to provide a connecting member for the handle of a pan, which mitigates the above drawback.

### SUMMARY OF THE INVENTION

The primary purpose of the present invention is to provide a connecting structure to the handle of a pan (having a pan body). The connecting member, which is attached to the handle is characterized by the ability to conduct heat energy. The top face of the connecting member is provided with a temperature sensing element, thereby the heat from the pan body is transferred via the edge of the pan body to the connecting member, so that the temperature sensing element of the connecting member can detect the temperature in which a color change is obtained to provide an indication of temperature.

Yet another object of the present invention is to provide a connecting member to the handle of a pan, wherein the temperature sensing element is a liquid temperature sensing coating.

Sill a further object of the present invention is to provide a connecting member to the handle of a pan, wherein the temperature sensing element is a solid state adhesive which can adhere onto the connecting member.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the present invention.

FIG. 2 is a sectional view of the present invention.

FIG. 3 is a schematic view showing the application of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

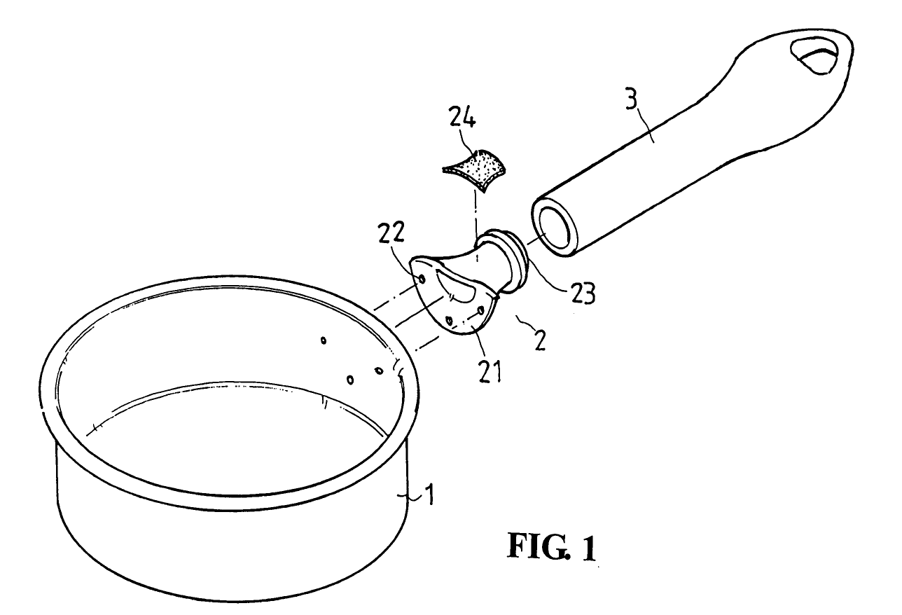

Referring to FIG. 1, there is shown a connecting member to the handle of a pan comprising a pan body 1, a connecting element 2 and a handle 3.

The pan body 1 is a container which is directly heated to cook food contained in the pan. One end edge of the pan body 1 is mounted with the connecting member 2.

The connecting member 2 is a heat conduction element which has an end provided with a holding face 21. The holding face 21 has a locking hole 22, and the other end is provided with a connecting end 23 for connecting to the handle 3. The center of the connecting member 2 is provided with a temperature-sensing element 24.

The handle 3 is correspondingly mounted at the connection end 23 of the connecting member 2 to provide holding by the user.

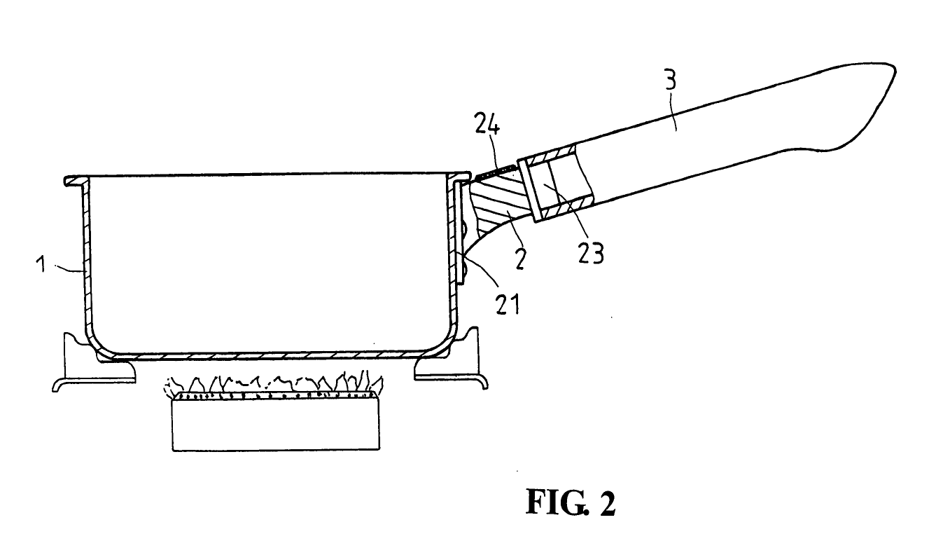

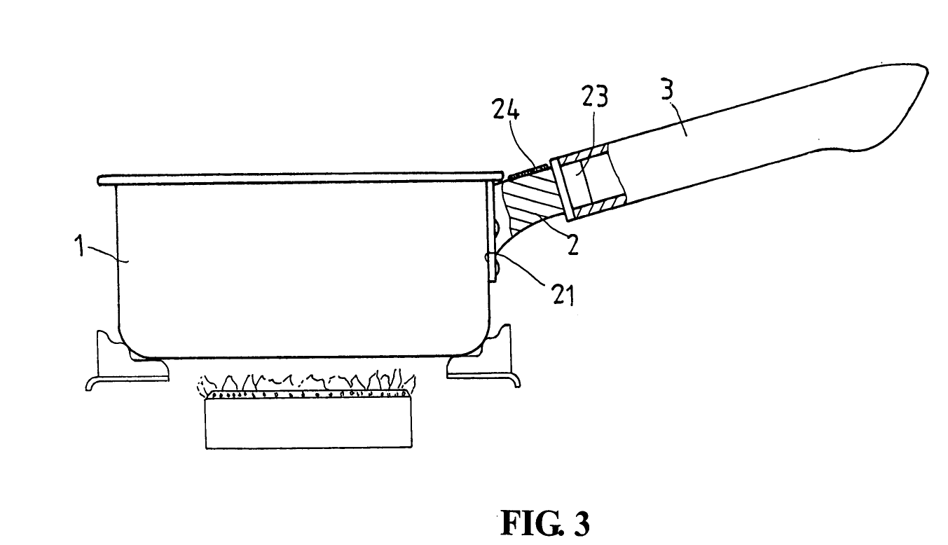

Referring to FIGS. 2 and 3, the center position of the connecting member 2 corresponds with the temperature-sensing element 24, and the holding face 21 of the connecting member 2 is adhered correspondingly to the end edge of the pan body 1, and a locking member is used for locking the connecting member 2. After that, the handle is mounted to the connecting end of the connecting member 2. When in application, the pan is placed on a stove and the heat from the stove heats the pan body 1 and the temperature reaches the pan body 1. The temperature will reach the temperature-sensing element 24. When at a certain temperature, the temperature-sensing element 24 causes a change in color so as to indicate the temperature of the pan body 1.

The temperature-sensing element 24 can be a coated liquid, or a solid state element or an electronic device, and the coating of a liquid can be achieved with coated materials which can show 50° C., or 60° C., etc, or electronic element with liquid crystal display.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. The connecting member, which is attached to the handle is characterized by the ability to conduct heat energy. The top face of the connecting member is provided with a temperature sensing element, thereby the heat from the pan body is transferred via the edge of the pan body to the connecting member, so that the temperature sensing element of the connecting member can detect the temperature in which a color change is obtained to provide an indication of temperature.

2. The connecting structure of a handle of a pan of claim 1, wherein the temperature sensing element is a liquid temperature sensing coating.

3. The connecting structure of a handle of a pan of claim 1, wherein the temperature sensing element is a solid state adhesive which can adhere onto the connecting member.

4. The connecting structure of a handle of a pan of claim 1, wherein the temperature sensing element is a sensing electronic element and the detected temperature is shown at the liquid crystal display.
